(19) United States
(12) Patent Application Publication
(10) Pub. No.: US 2004/0205133 A1
(43) Pub. Date: Oct. 14, 2004

(54) System and method for intelligent transmission of digital content embedded in electronic mail messages

(76) Inventor: Yaron Adler, Tel Aviv (IL)

Correspondence Address: Brown Raysman, Millstein Felder & Steiner, 900 Third Avenue, New York, NY, 10022, US

(21) Appl. No.: 10/333,512

(22) PCT Filed: Jul. 18, 2001
(86) PCT No.: PCT/IL01/00662

Related U.S. Application Data
(60) Provisional application No. 60/219,385, filed on Jul. 19, 2000.

(51) Int. Cl. G06F 15/16

(52) U.S. Cl. 709/206

(57) ABSTRACT

The present invention discloses a method and system for transmitting electronic mail messages containing multimedia elements that reduces bandwidth usage and transmission time. The present invention comprises embedding one or more multimedia elements within an electronic mail message where each multimedia element is identified by a globally unique identifier. Each multimedia element contained within the electronic mail message is replaced with a reference to its globally unique identifier. The electronic mail message is transmitted to an intended recipient and the intended recipient replaces each globally unique identifier contained in the electronic mail message with the corresponding multimedia element upon receipt. The method further comprises transmitting to a smart server a listing of the globally unique identifiers for each multimedia element contained within the electronic mail message, the smart server storing multimedia elements indexed by globally unique identifier, searching to identify globally unique identifiers contained in the transmitted listing that are stored on the smart server, and transmitting to the smart server all multimedia elements not identified by the search as being stored on the smart server. The multimedia elements are retrieved by the intended recipient from the smart server and each globally unique identifier contained in the electronic mail message is replaced with its corresponding multimedia element.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

The invention disclosed herein relates generally to accelerating the delivery speed of multimedia content. More particularly, the present invention relates to the use of caching to maximizing the delivery speed of email containing embedded multimedia elements while also minimizing the amount of bandwidth used to execute the delivery.

Electronic mail, or email, is an increasingly popular medium used by people to communicate with one another. Using email, a person can send textual messages and other information electronically to other email users. Information that can be attached to or embedded within an email message includes pictures, sound recordings, video, and virtually any other content that is in a digital form. Email communication systems can be described as multicast store-and-forward communications systems, allowing users to send messages to one or more recipients at a time. Most systems can also be described as bi-directional, as they usually allow a user to both send and receive messages.

When using email to communicate, a user will typically create a message by interacting with electronic mail client software running on a computer that is connected by a network to other computers. Alternatively, the user's computer can be connected to the network on demand, such as through the use of a modem in conjunction with a dial-up account provided by an Internet Service Provided (ISP). In addition to the substantive contents, the message will include the network address of the intended recipient. When the user has finished composing the message, it is electronically transmitted via a network to the intended recipient. The recipient, also running electronic mail client software on a computer connected to a network, receives the message and can examine its contents.

A common computer network used to send and receive email is the Internet. The Internet allows users to exchange email with computers located throughout the world. Typically, each user will have an Internet email address that is unique to the particular user. The syntax of an Internet mail addresses is username@domainname, e.g., mark@prodigy.com. A user with an email account and a computer capable of connecting to the Internet can easily send and receive messages over the network.

As email has evolved, advanced mail clients have integrated the ability to incorporate and display Hypertext Markup Language (HTML) formatting in email messages. When drafting a message, the author makes use of HTML “tags” to instruct the application presenting the message how different elements should be formatted and presented on the user's display device. The use of HTML also allows complex multimedia elements to be included as part of the email message. These elements include everything from graphics and specialized typefaces to background images and wallpaper. Background images, e.g., are used to give a message the appearance that it was drafted on specialized stationary. Additionally, mail clients supporting this functionality allow users to attach other digital content to mail messages, such as electronic business cards and formatted documents.

When sending messages, multimedia elements tend to be reused on a regular basis, either by the same user or by a group of different users. Indeed, many email clients allow a user to embed a set of elements within a message template, which can provide a default formatting for newly created messages. In many cases, the same multimedia elements also tend to be reused by different users.

Unfortunately, because these elements are typically composed of sound, graphics and/or animation, they tend to carry a significant bandwidth overhead that results in increased transmission times. Due to the fact that current email systems have no mechanism to determine if a recipient has local copies of any elements contained in a message, all the elements must be transmitted each time a message is sent.

There is thus a need for a system that provides a mechanism to minimize the bandwidth used in the transfer of multimedia elements embedded within email messages. The present invention satisfies this need by providing a system that replaces elements with unique identifiers. The unique identifiers are used to determine if an element embedded in an email resides on a recipient's local storage device, obviating the need for it to be transferred. Although the system eliminates the transfer of these elements, recipients are still able to see a message with the formatting and elements intended by the message's author. The bandwidth benefits provided by the instant invention will be apparent to the user by the fact that a message with multiple multimedia elements embedded within it will have a reduced transfer time. The mechanics involved in reducing bandwidth requirements, however, will remain transparent to the user.

### BRIEF SUMMARY OF THE INVENTION

The present invention achieves its purpose through the use of a specialized “smart server”. The smart server is coupled to a database containing a library of “multimedia elements”, or simply “elements”. Elements can consist of any digital media designated by the user, such as sound or graphics, which are assigned a unique identifier. Associating each element in the system with a unique identifier allows for convenient indexing within a system database according to these identifiers. Message authors draft their messages and embed any desired elements, including images, sounds, and animations, which are contained on their local storage device, e.g., fixed hard drive. Each element, whether located on a user's local storage device or on the system database, is associated with a globally unique identifier.

Once the message is composed, but before it is transmitted, each element contained within the message is identified. Once identified, the element is removed from the message and replaced with its unique identifier. The message is sent to its recipient using protocols well known to those skilled in the art, such as the Simple Mail Transfer Protocol (SMTP). The smart server is simultaneously informed of all the multimedia elements contained in the recently sent message. The smart server replies to the client with a list of all elements that are not contained in its database. The client software will transmit the unknown elements to the smart server along with their unique identifiers, which are then added to the smart server's database.

The message recipient downloads the email message using any number of protocols well known to those skilled in the art, e.g., IMAP or POP3. The recipient's mail client software will extract the unique identifiers from the mail message. The list of extracted unique identifiers is compared against the client's local cache and elements that are in the cache are merged back into the received message. If the message contains elements that are not present in the recipient's local cache, the smart server is contacted and passed the list of unknown unique element identifiers. The server will respond by downloading the appropriate elements into the message recipient's local cache. The client software will then merge the received element or elements into the message. The email message, containing all the multimedia elements included by the message's author, is presented to the recipient.

The system is designed to significantly decrease the communication time required to transmit or receive an email message. If an element is stored on the smart server there is no need to transfer the element, eliminating the time required to send the elements along with the message itself. As a result, the communication time required to send an element is reduced to once for all users. As for the receiving side, the communication time is reduced to once for every user. Indeed, commonly used clip-art and image libraries consisting of many commonly used elements can be pre-loaded onto the smart server system to allow users to immediately benefit from speed increate provided by the system, saving communication time for even the first transmission. Similarly, when a user's local cache contains elements associated with the unique element identifiers contained in a received message, there is no need to transfer the elements themselves across the network. Common elements can also be pre-loaded into a user's element cache to further eliminate the need to transfer large amounts of data over the network while sill providing the elements that users desire.

The system can also be modified to track the elements that are being used and the people who are using them. Every time a message is sent, the system records transaction information to a database. Information collected includes the unique element identifier, the identity of the sending party, the identity of the receiving party, and the transaction time and date. This data can then be used to generate various statistics regarding the use of the system.

### BRIEF DESCRIPTION OF THE DRAWINGS

The invention is illustrated in the figures of the accompanying drawings, which are meant to be exemplary, and not limiting, in which like references are intended to refer to like or corresponding parts, and in which:

FIG. 1 is a block diagram showing the multiple hardware and software components of a system to intelligently deliver email containing multimedia elements according to one embodiment of the present invention;

FIG. 2 is a block diagram showing the multiple hardware and software components of a system to intelligently deliver email containing multimedia elements according to a second embodiment of the present invention;

FIG. 3A is a block diagram showing the components needed to track the use of multimedia elements according to one embodiment of the present invention;

FIG. 3B is a flow diagram showing a method of capturing and archiving information regarding the use of multimedia elements according to one embodiment of the present invention;

FIG. 4 is a flow diagram outlining a method of intelligently sending electronic mail containing multimedia elements according to one embodiment of the present invention;

FIG. 5 is an additional flow diagram outlining a method of intelligently sending electronic mail containing multimedia elements according to one embodiment of the present invention; and

FIG. 6 is a flow diagram showing a method of intelligently retrieving electronic mail containing multimedia elements.

### DETAILED DESCRIPTION OF THE PREFERRED EMBODIMENTS

An element according to the present invention encompasses virtually all digital content that can be embedded within an email message. Exemplary elements include image files, sound files, and even digital business cards. In order for the invention to properly retrieve requested elements, each element must have an associated unique alphanumeric identifier that is used to identify, retrieve, and track elements. Although virtually any digital content can be an element, only those that are associated with a unique id are elements that will be recognized and acted upon by the invention. Unassociated content that is simply embedded within a document will be ignored by the system and delivered according to techniques that are well known in the art. Alternatively, as will be explained more fully herein, unassociated elements are associated with unique identifiers upon transmission of a message that they are incorporated in.

The server will be unable to recognize an element without a unique id. Because the unique identifier must accompany the element wherever it goes, the two must be packaged together. One way to achieve this is to pack the file or files that comprise the multimedia element together with a textual descriptive file, e.g., a .ini file, into one file. The textual file can also hold additional information regarding the object, such as the name of the file, the type of file, and the name and contact information for the file's author. Business logic contained within the system allows the element to be unpacked and the unique id retrieved.

When a user creates a new element, it must be assigned a unique identifier so the smart server does not confuse the element with other elements already in distribution. One way to do this is to use a unique global identification system, such as the GUID system used by Microsoft to identify COM objects. Each client runs an instance of the GUID software that generates an extremely large 128-bit number. The software makes use of an algorithm that is guaranteed to generate numbers that are unique in both time and space. When a new element is embedded in an email message, the client software will generate an unused unique identifier and seamlessly pack the identifier together with the element. Alternatively, unique identifiers can be generated by the smart server using techniques that are will know in the art. All elements in the message are then transmitted according to the methods described herein. According to this configuration, the smart server acts as an authority that both the controls the distribution and enforces the uniqueness of the element identifiers.

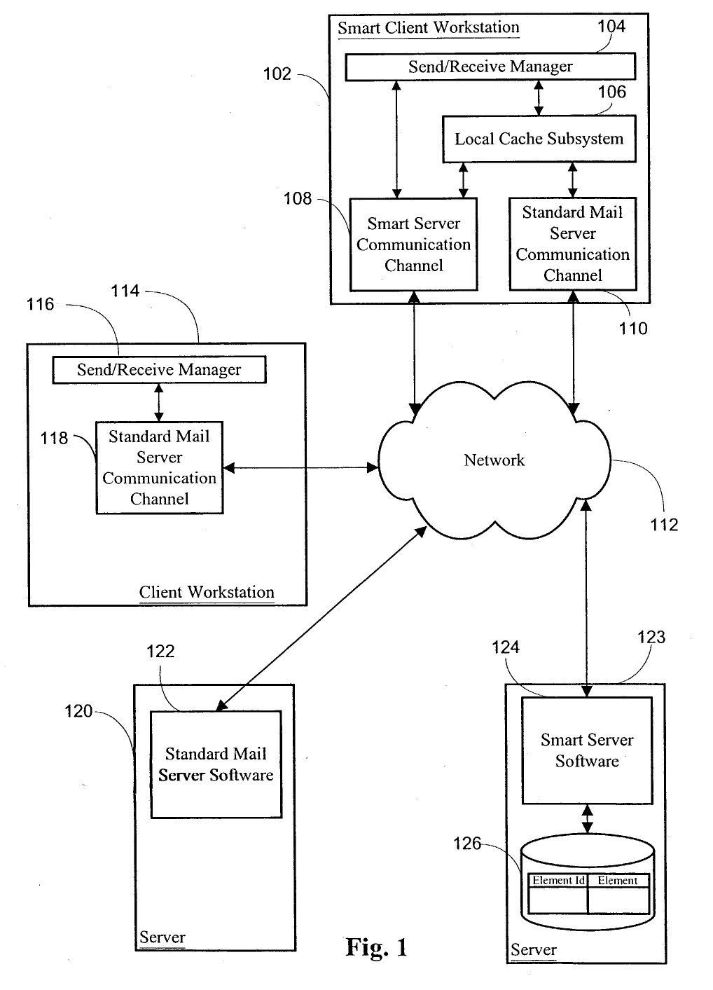

Referring to FIG. 1, a block diagram is presented that shows the multiple hardware and software components of a system for intelligently delivering email containing multimedia elements. Electronic mail client software 104 to 110 is run locally on a user's workstation 102. The user of the client software interacts with a smart send/receive manager 104, which is responsible for sending a receiving email messages. The smart send/receive manager also executes the business logic that facilitates the intelligent transfer of multimedia elements embedded in email messages. While the smart send/receive manager 104 is depicted as one component, it can easily be divided into two separate components, e.g., one for sending and one for receiving.

All elements that are transmitted to or from a client computer are copied to a local cache 106. As will be explained in further detail herein, the cache is used as a local element repository that will be utilized by the client software to maximize the transmission speed of email delivery. The client uses the standard mail server communication channel 110 to send and receive standard email by using protocols that are well know to those skilled in the art. The client uses the smart server communication channel 108 to handle communication with the smart server and to transfer elements. Each of the communication channels 108 and 110 are electrically coupled to a computer network 112 that is used to transfer email data between clients and servers.

Also connected to the network are server computers 120 and 123. A server accepts requests from client computers and returns data that is responsive to the request. Server computer 120 is configured to run a standard electronic mail server software package 122. This mail server package uses protocols such as SMTP, POP3, and IMAP to facilitate the transfer of email messages between authors and recipients. Examples of currently available standard mail server software packages include Microsoft Exchange Server from Microsoft Corp. and SendMail, which is freely available from the SendMail Consortium at www.sendmail.org.

Server 123 is configured to run the smart server software package 124. The smart server 124 is a software package that is used to handle the intelligent transfer of multimedia elements between authors and recipients in a manner detailed herein. The smart server software 124 communicates with a database 126 that contains a series or index of elements with their associated unique identifiers. The database is controlled by a commercially available Relational Database Management System (not pictured), such as those offered by Oracle or Sybase. The database 126 can be stored on a local or networked storage volume and need not physically reside on the same computer executing the smart server software. It is important to note that while the smart server 123 is centralized for all smart clients 102, multiple standard mail servers 120 can be used by different standard client workstations 114.

Other workstation computers that are running standard electronic mail client software 114 may also be connected to the network. These clients are equipped with software components to handle the sending and receiving of standard email messages 116, as well as a communication channel 118 to conduct the transfer of messages between the client and the standard server. Since these clients lack a smart server communication channel 108, as well as functionality provided by the smart send/receive manager, all communication with the server will access only the standard mail server software 122.

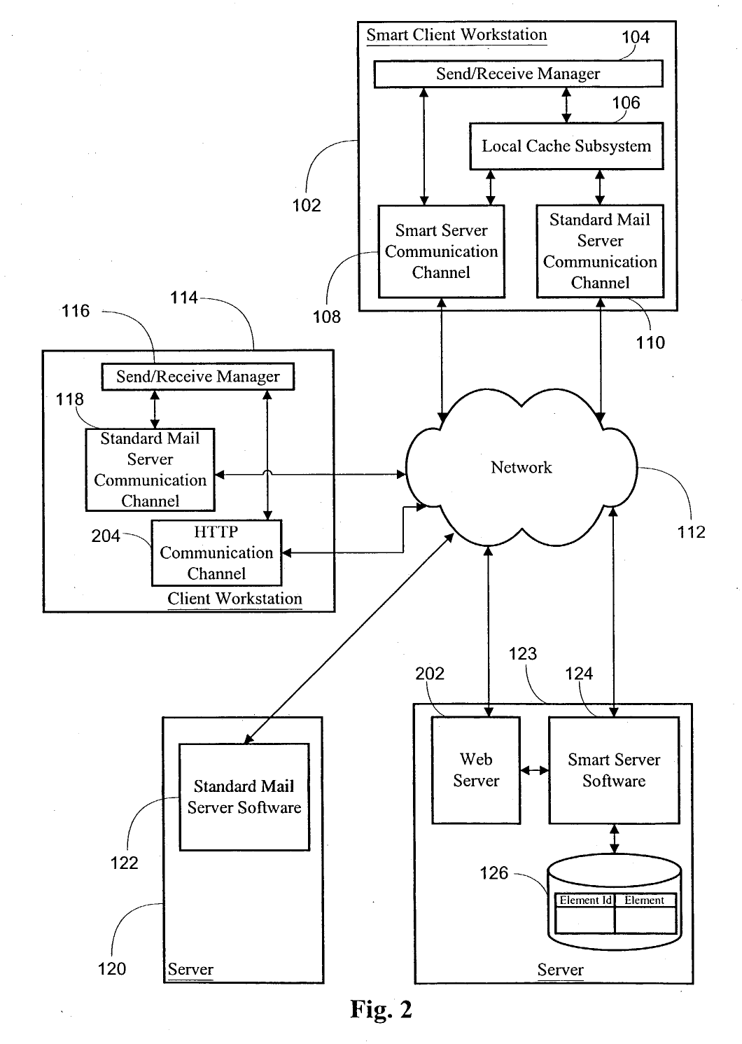

FIG. 2 is a block diagram showing a second embodiment of the multiple hardware and software components of a system to intelligently deliver email containing multimedia elements with support for standard mail clients. In this embodiment, a web server 202 has been added to the server computer that is executing the smart server software package. It will be apparent to one skilled in the are that the web server software can be run on any computer that can communicate over a network with the computer running the smart server software. Elements contained in the database are copied to a local filesystem. While messages are configured to contain both unique identifiers and element URLs to identify embedded elements, standard email clients will utilize only the URLs to retrieve elements from the web server using a Hypertext Transfer Protocol communications channel. Likewise, smart mail clients will utilize only unique identifiers and ignore element URLs contained in a message. An exemplary way of doing this would be for either the client or server to create a unique web address comprised of the server and domain, the unique identifier, and the filename of the element, e.g., http://www.smart-server-domain.com/elements/<unique identifier>/<filename>. Every time an element is added to the database, it is copied to the filesystem to ensure that the two are synchronized.

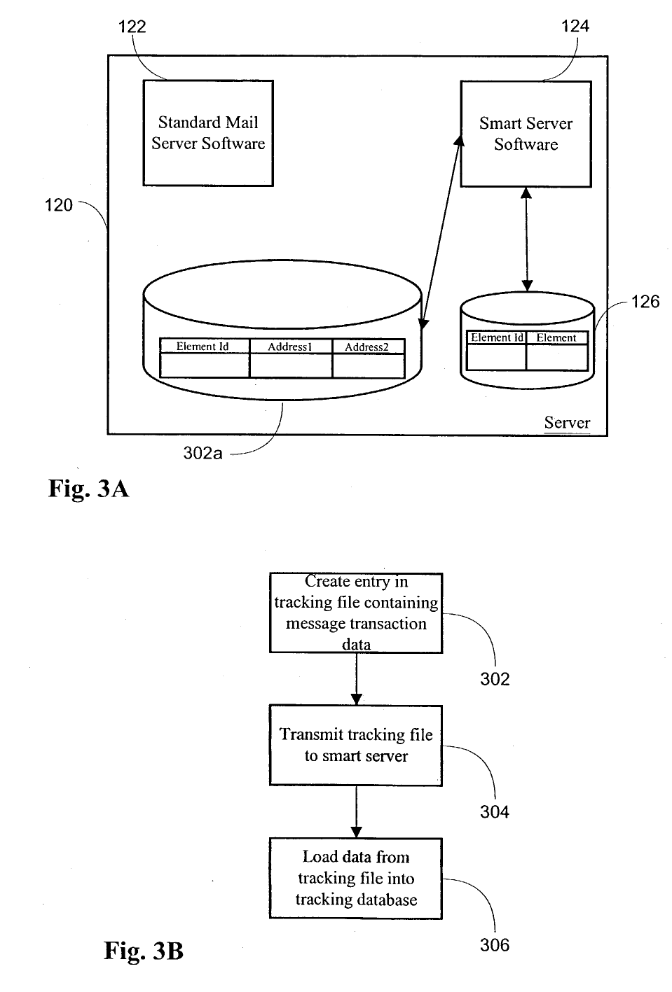

FIGS. 3A and 3B present an embodiment of the system and method that allows for information regarding the usage of multimedia elements to be tracked. The smart server software accesses an additional database 302a that contains tracking data for each element. Although the database is depicted as a storage peripheral connected to the server running the smart server software, the system can be configured such that the database can reside anywhere on any network that is accessible by the computer on which the smart server is running. Alternatively, the data can be loaded into database 126 as a separate table or tables under the control of a single Relational Database Management System (RDBMS).

For each message a user composes that contains multimedia elements, the client software creates an entry in a tracking file 302. The tracking file contains all data regarding the message transaction, such as the unique identifier for each element in the message, the user name of the message's author, the user name of the message's recipient, and the time and date of the transaction. On a periodic basis, e.g., each time a user ends a dial-up session with his or her ISP, the client software will transmit a copy of the tracking file to the smart server 304. Upon receiving the tracking file, the smart server will load it into the tracking database 306. Alternatively, the tracking data can be recorded and transmitted for each message as it is sent to its intended recipient. This data can then be used both to monitor use of the system and for market analysis purposes.

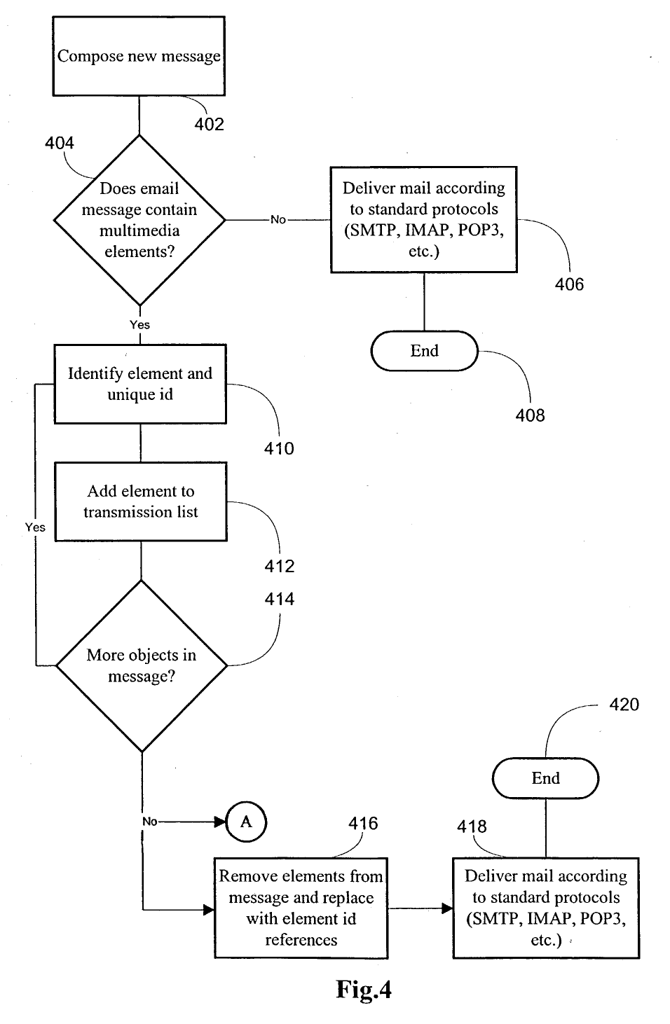

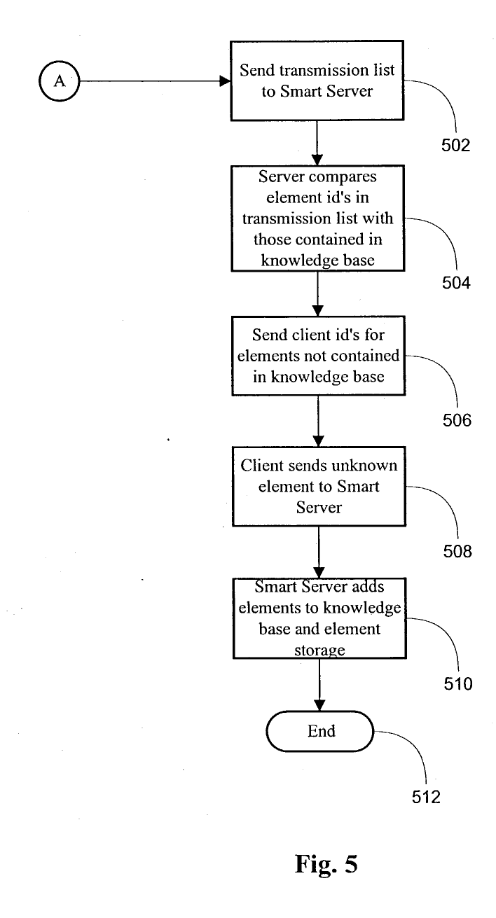

Turning to FIGS. 4 and 5, one embodiment of the method for intelligently transmitting multimedia elements contained in an email message is presented. A user interacts with the smart mail client to compose a message 402. Controls are provided to select a plurality of multimedia elements to embed within the message. Once the message is complete, the user instructs the client software to transmit it to the designated recipient or recipients.

The client software begins pre-delivery processing by determining if the message contains any multimedia elements 404. If no elements are present, the software will pass control off to the standard mail server for delivery according to well-established protocols 406 and processing ends 408. If the software determines that message contains elements, the initial element and its unique id are retrieved 410. The unique identifier associated with the element is added to a transmission list 412, which contains the identifiers for all elements embedded within the message. If there are more elements in the message 414, processing returns to step 410 and the loop is re-executed.

After each element contained in the message has been identified and recorded in the transmission list, all embedded elements are stripped from the message. This results in the plain text of the email with none of the multimedia elements applied by the user. In place of the elements, the client software will traverse the transmission list and insert the set of unique identifiers into the message 416. The unique identifiers will be inserted into the email in a place that the user does not typically have access to or interact with. For example, when a user is sending a message composed of HTML that is going to be rendered as a page, the client embeds the identifiers within the HTML as a comment that is ignored by the rendering engine and therefore transparent to the user. The information can also be placed within the header of the HTML page as Meta data. Alternatively, the identifier information can be written within a message's MIME header, which is used to instruct current mail servers as to how a message should be delivered. The message is delivered according to well-established protocols 418 and processing on the client side completes 420.

Referring to FIG. 5, a copy of the transmission list is sent to the smart server 502 as the client software is replacing elements in the email message. The smart server queries its element database with the unique element identifiers contained in the transmission list used as parameters 504. The smart server sends a report back to the client containing a list of unknown identifiers 506. For each unknown identifier, the client will retrieve the packaged element from its local element cache and deliver it to the smart server 508. As the smart server receives the elements, the unique identifier is added as a new record in the database 510. The database is also used by the smart server as a repository for the elements themselves.

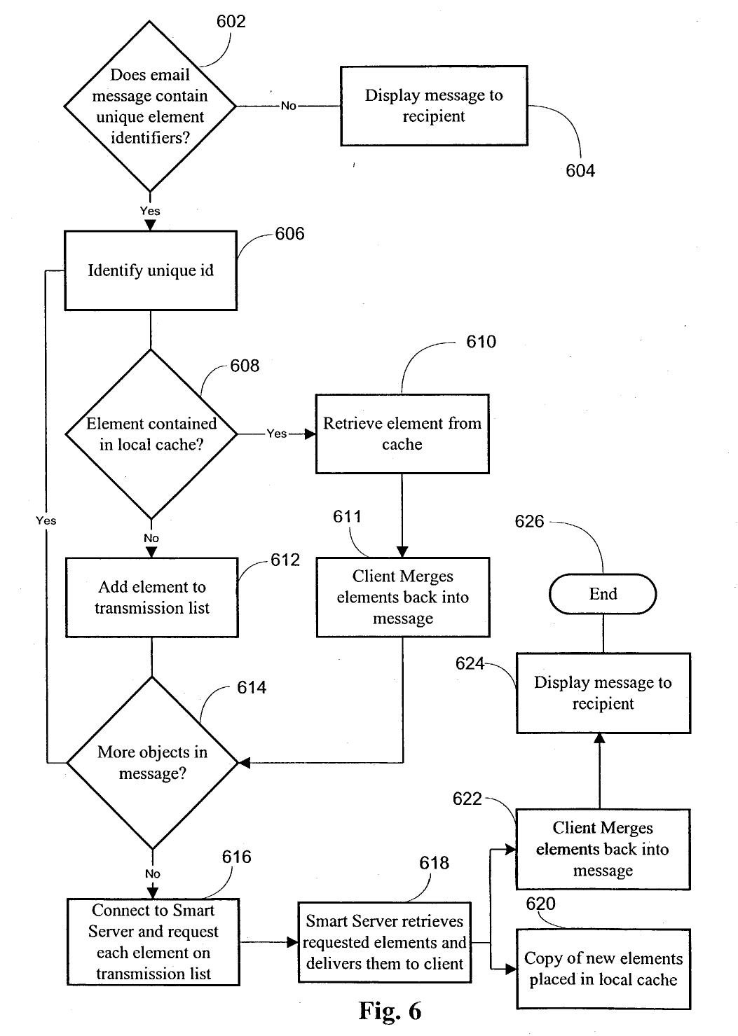

FIG. 6 presents one embodiment of the method for intelligently receiving multimedia elements contained in an email message. When the smart email client software receives a message from the standard mail server, it determines whether or not it contains any unique element identifiers 602. If there are no identifiers contained in the message, it is displayed to the recipient 604. Where identifier are present in a received message 606, the client software queries its local element cache to determine if it holds a local copy of the element 608. If a local copy of the element exists, it is retrieved from the cache 610 and merged back into the received email message 611. Where the element is not held in the local cache 608, the identifier is appended to a transmission list 612 and the loop is repeated for each element contained in the message 614.

All unknown elements are added to the transmission list and a connection is opened with the smart server 616. The list of unknown unique identifiers is transmitted to the smart server once the connection is opened. Upon receiving the list, the smart server will query its database and generate a result set comprising all elements specified in the transmission list. The elements are returned to the client 618. When the client receives the unknown elements, a copy of the set is generated and placed in the local cache 620. This eliminates the need to access the smart server when the element or elements are encountered in the future. The elements are then merged into the email message 622. At this point, all the multimedia elements that were removed upon delivery have been merged back into the message, either by retrieving them from the local cache or having them transmitted from the smart server. The message is presented to the recipient 624 and processing ends 626.

The smart server system is also capable of operating in heterogeneous environments, e.g., those where certain workstations run standard email client software and others run smart email client software. When the process is executed using the system presented in FIG. 1, standard email clients will not be able to access the enhanced services of the smart server. When the standard client receives an email that contains unique element identifiers, the client will simply display the message without retrieving the elements. Since the unique identifiers are preferably placed in a non-visible area of the message, such as the MIME header, the user's ability to read the message is not affected. The process can also be executed on the system presented in FIG. 2 to allow for more robust support of standard mail clients. Because the message contains URLs in addition to element ids, standard mail clients can use standard HTTP protocols to retrieve the elements from a web server, while smart mail clients will ignore the URL and utilize only the unique element id to merge elements back into the received email message.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

What is claimed is:

1. A method for transmitting electronic mail messages containing multimedia elements that reduces bandwidth usage and transmission time, the method comprising:
embedding one or more multimedia elements within an electronic mail message, each multimedia element identified by a globally unique identifier;
replacing each multimedia element contained within the electronic mail message with a reference to its globally unique identifier;
transmitting the electronic mail message to an intended recipient; and
replacing each globally unique identifier contained in the electronic mail message with the corresponding multimedia element upon receipt by the intended recipient.

2. The method of claim 1, the method comprising:
transmitting to a smart server a listing of the globally unique identifiers for each multimedia element contained within the electronic mail message, the smart server storing multimedia elements indexed by globally unique identifier;
searching to identify globally unique identifiers contained in the transmitted listing that are stored on the smart server; and
transmitting to the smart server all multimedia elements not identified by the search as being stored on the smart server.

3. The method of claim 2, the method comprising:
retrieving multimedia elements by the intended recipient from the smart server;
replacing each globally unique identifier contained in the electronic mail message with its corresponding multimedia element.

4. The method of claim 1, the method comprising replacing each globally unique identifier with the corresponding multimedia element from a local cache.

5. The method of claim 1, the method comprising recording transaction information regarding the multimedia element or elements contained in the electronic mail message sent to the intended recipient.

6. The method of claim 5, the method comprising generating statistical information regarding the use of multimedia elements through analysis of the recorded transaction information.

7. A method for transmitting electronic mail messages containing multimedia elements that minimizes bandwidth usage and transmission time, the method comprising:
embedding one or more multimedia elements within an electronic mail message, each multimedia element identified by a network address indicating where a file containing the element resides on a network;
replacing each multimedia element contained within the electronic mail message with a reference to the network address indicating where the file containing the element resides on the network;
transmitting the electronic mail message to an intended recipient; and
replacing each network address indicating where the file containing the element resides on the network contained in the electronic mail message with the corresponding multimedia element upon receipt by the intended client.

8. The method of claim 7, the method comprising:
transmitting to a smart server a listing or index of the network addresses indicating where the file or files containing the multimedia elements reside on the network for each element contained within the electronic mail message, the smart server storing multimedia elements indexed by network address; and
searching to identify network addresses contained in the transmitted listing that are stored on the smart server; and
transmitting to the smart server all multimedia elements not identified by the network address search as being stored on the smart server.

9. The method of claim 8, the method comprising:
retrieving multimedia elements according to the network address indicating where the file containing the element resides on the network; and
replacing each network address contained in the electronic mail message with its corresponding multimedia element.

10. A system for transmitting electronic mail containing multimedia elements that minimizes bandwidth usage and transmission, the system comprising:
a smart email client operative to identify multimedia elements contained in the electronic mail message, replace each multimedia element with the element's globally unique identifier, and generate a listing or index of the unique identifiers contained in the electronic mail message for transmission to a smart server, the electronic mail message transmitted to its intended recipient; and
a smart email server operative to receive the listing or index generated by the smart email client, identify unique identifiers for unknown multimedia elements, receive copies of the unknown multimedia elements, and respond to requests from smart email clients for known multimedia elements.
